(19) United States
(12) Patent Application Publication
(10) Pub. No.: US 2004/0126203 A1
(43) Pub. Date: Jul. 1, 2004

(54) Fixing assembly comprising a peg and a sleeve

(76) Inventor: Katell Decamp, Chambourcy (FR)

Correspondence Address: GREENBERG TRAURIG, LLP, 885 3RD AVENUE, NEW YORK, NY, 10022, US

(21) Appl. No.: 10/666,469

(22) Filed: Sep. 19, 2003

(30) Foreign Application Priority Data
Sep. 19, 2002 (FR) 02 11608

(51) Int. Cl. F16B 19/08

(52) U.S. Cl. 411/502

(57) ABSTRACT

The peg (1) and the sleeve (30) of the invention are intended to be push-fitted one inside the other to fix a component to a support, for example to fix an inertial unit to a rack. The peg (1) comprises an anterior introduction portion (2) of frustoconical shape, and a posterior fixing portion (3) consisting of a cylindrical part (4) and of a posterior part (5) of frustoconical shape, the vertex of the cone of the latter portion facing in the opposite direction to that of the anterior portion (2). The diameter of the cylindrical part (4) of the posterior fixing portion (3) of the peg (1) is longer than the diameter of the sleeve (30). This peg (1) is slotted (8). The peg (1) is coated with a graphite deposit.

The present invention relates to an assembly of a peg and of a sleeve of a component and of a support which are intended to be push-fitted one into the other to fix the component to the support, the peg comprising an anterior portion to be introduced with clearance into the sleeve and a posterior fixing part.

A system is commonly held on a support using a number of pegs push-fitted into sleeves provided for that purpose. For example inertial units are equipped with sleeves into which the pegs of a support, commonly known as a rack, are push-fitted. The term “rack” will be used hereinafter to denote any type of support likely to possess fixing pegs, such as a true rack, a trestle, a casing, a chassis, etc. The rack is secured to the craft, for example an aircraft, equipped with the inertial unit, allowing the inertial unit to be subjected to the same movements as the craft, the inertial unit being locked in terms of translation on the pegs by a locking system that is independent of the pegs.

The problem underlying the present invention relates to an inertial unit, but it goes without saying that the applicant company does not thereby intend to restrict the scope of its application to this domain, the latter having to extend to cover any assembly of a peg and of a sleeve.

In the case of inertial units, there are generally three pegs, one at the front and two at the rear of the rack. When the inertial unit is mounted on the rack, the three pegs are inserted simultaneously in their respective sleeves on the unit. In order to allow this insertion, there is clearance between the pegs and their corresponding sleeves, generally afforded by a conical anterior introduction portion of the pegs, in front of a cylindrical posterior portion. The diameter of the cylindrical posterior portion of the pegs is smaller than that of the sleeves. This clearance makes it possible to compensate for manufacturing tolerances and to fit the pegs into their sleeves, because it is practically impossible to make the three peg-sleeve assembly respectively coaxial simultaneously. The clearance also makes it easier to mount and to demount the unit, and therefore assists with inertial unit interchangeability.

However, the clearance poses a problem with respect to the precision of the inertial unit. This is because since the unit is subjected to vibration, the clearance allows a relative movement between the inertial unit and the rack, and therefore between the unit and the aircraft, introducing errors into the measurements. Furthermore, in the inertial unit there are inertial sensors which, in real time, measure acceleration and rotation data which are then compiled in a mathematical model in order to deduce from this the position of the aircraft in space. These models need to be calibrated, that is to say that their parameters are determined experimentally. Now, as the clearance cannot be predicted from one unit to another, it is impossible to predict the influence it will have on the model, and this leads to a lack of precision in the calculations. It has been calculated that, with an inertial unit fixed on the rack, without clearance, the errors would be three to four times lower.

The present invention aims to alleviate these disadvantages.

To this end, the present invention relates to an assembly of a peg and of a sleeve of a component and of a support which are intended to be push-fitted one into the other to fix the component to the support, the peg comprising an anterior portion to be introduced with clearance into the sleeve and a posterior fixing part, characterized in that the posterior part of the peg is designed to compensate for the clearance.

By virtue of the invention, the component can easily be mounted on and demounted from the support without the fixing of the component thereby being affected.

In the preferred embodiment of the invention, the diameter of the posterior fixing part of the peg is greater than the diameter of the sleeve, and the peg is slotted.

Advantageously, the peg has lateral flaps.

As another preference, the posterior fixing portion comprises a part that does not compensate for the clearance.

As another preference, the posterior fixing portion comprises a cylindrical part and a frustoconical rear part behind the cylindrical part.

Advantageously, the peg is coated with a graphite deposit.

The invention will be better understood with the aid of the following description of the preferred embodiment of the invention, with reference to the attached drawing, in which:

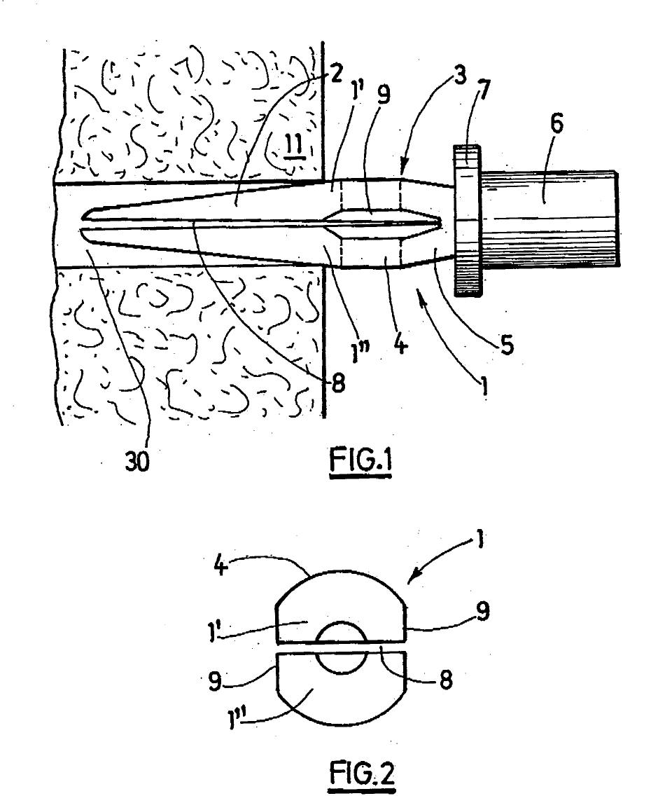

FIG. 1 depicts a profile view of the assembly according to the present invention;

FIG. 2 depicts an end-on view of the peg of the assembly of FIG. 1, and

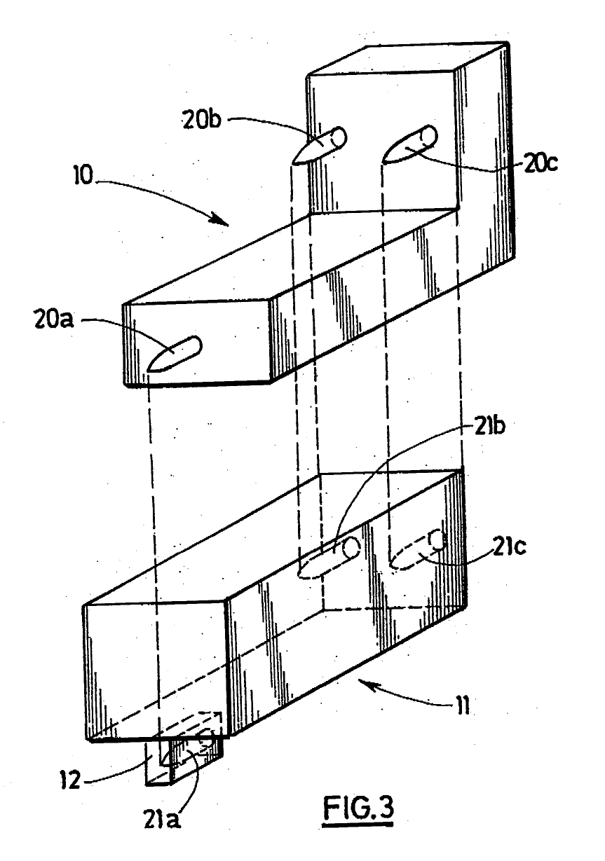

FIG. 3 depicts an exploded view of the assembly of an inertial unit on a rack, using assemblies according to FIGS. 1 and 2.

With reference to FIGS. 1 and 2, the peg 1 of the assembly of the invention comprises an anterior introduction portion 2, of frustoconical shape, and a posterior fixing portion 3, which itself comprises a cylindrical part 4 and a frustoconical posterior part 5, the vertex of the cone of the frustoconical posterior part 5 facing in the opposite direction to that of the anterior portion 2. The peg 1 also has a portion 6 for push-fitting into a rack 10 (FIG. 3) and a stop 7, these two elements collaborating in the fixing of the peg 1 on the rack 10. A longitudinal slot 8, here an axial slot, is made along the peg 1 over the entire width of the peg 1 and at least as far as the start of the frustoconical posterior part 5. Two diametrically opposed lateral flaps 9 are made on the cylindrical part 4 and on part of the anterior introduction portion 2 and of the frustoconical posterior part 5 adjacent to the cylindrical part 4. The peg 1 is designed to be push-fitted into a sleeve 30 of an inertial unit 11. The diameter of the cylindrical part 4 is greater than that of the sleeve 30.

With reference to FIG. 3, the rack 10 comprises three pegs 20a, 20b, 20c which point in the same direction in the horizontal plane, two pegs 20b, 20c lying in the same vertical plane, to the rear of the rack 10, and the third 20a lying at the front of the rack, in a different horizontal plane to the one containing the other two pegs 20b, 20c. The inertial unit 11 has three sleeves 21a, 21b, 21c of cylindrical hollow shape over at least an introduction portion. Two of the sleeves 21b, 21c lie in the same vertical plane; the third sleeve 21a lies, at the front, in a different horizontal plane to the one containing the other two sleeves 21b, 21c, in a piece 12 attached to the unit 11. The inertial unit 11 is fixed to the rack 10; for this, the pegs 20a, 20b, 20c are push-fitted into the sleeves 21a, 21b, 21c, respectively; a system for locking in the direction of the pegs is also provided, but is not depicted here, as it is well known to those skilled in the art.

Let us now describe the way in which the sleeve-peg assembly of the present invention behaves when the inertial unit 11 is being fixed to the rack 10. In the description which follows, when mention is made of the peg 1 or of the sleeve 30, it must be understood that this relates to the way in which any one of the pegs 20a, 20b, 20c or of the sleeves 21a, 21b, 21c, respectively behaves. Furthermore, the various portions and parts of the peg 1 are the same for all the pegs 20a, 20b, 20c.

At the start of insertion of the inertial unit 11 onto the rack 10, it is possible to position and to begin to insert the pegs 20a, 20b, 20c without any problem by virtue of their anterior introduction portion 2 which is of conical shape. There is therefore no need to position the pegs 20a, 20b, 20c very precisely with respect to the sleeves 21a, 21b, 21c.

The end of the anterior introduction portion 2 has the same diameter as the cylindrical part 4 of the peg 1, therefore a diameter greater than that of the sleeve 30. Thus, during insertion, and before the end of the anterior introduction portion 2 is reached, the peg 1 comes to bear against the edge of the sleeve 30, as can be seen in FIG. 1. If insertion is continued, by force, this has the affect of causing the two half-portions 1′, 1″ of the peg 1 to bend on either side of the slot 8, into the space of the slot 8, and therefore to allow the continued insertion of the peg 1. It is therefore possible to introduce the cylindrical part 4 of the peg 1 by virtue of the flexing of its two half-portions 1′, 1″.

The flexing takes place in the direction perpendicular, when viewed in cross section, therefore for example in FIG. 2, to the slot 8. The diameter of the peg 1 is thus adapted to suit that of the sleeve 30. However, in the direction of the slot 8, still in the view in cross section, there is no flexing, hence the need for the flaps 9, which allow the diameter of the peg 1 to be, in this direction, smaller than that of the sleeve 30, and therefore allow the peg 1 to enter the sleeve 30. The said flaps 9 are present throughout the region of the peg 1 whose diameter is greater than that of the sleeve 30. These types of flaps 9 are well known to and are reproducible by the person skilled in the art.

At the end of insertion, because of its conical shape, the force exerted by the peg 1 on the sleeve 30 of the inertial unit 11 no longer varies. The benefit of this frustoconical posterior part 5 is therefore that it stabilizes the force between the peg 1 and the sleeve 30 at the end of insertion.

The peg 1 is therefore finally anchored in the sleeve 30, because of the force it exerts on the sleeve 30, this force being due to the flexing of the two elastic half-portions 1′, 1″. There is no longer any clearance between the pegs 20a, 20b, 20c and the sleeves 21a, 21b, 21c. The forced flexing of the pegs 20a, 20b, 20c has made it possible to compensate for manufacturing tolerances.

Resonance of the peg-sleeve systems is of course envisageable. However, should it arrive, it will be at a frequency below 2000 Hz, which does not adversely affect the work of the sensors in the inertial unit 11.

Advantageously, through a graphite treatment, a graphite deposit will be applied to the pegs 20a, 20b, 20c in order not only to facilitate the penetration of the pegs 20a, 20b, 20c into the sleeves 21a, 21b, 21c, but also to reduce corrosion.

It is possible to envisage the presence of several slots on the peg 1, for example two perpendicular slots, or three slots in star configuration, etc.

Described hereinabove is an inertial unit 11 to be fixed to a rack 10 by pegs 20a, 20b, 20c on the rack 10 and sleeves 21a, 21b, 21c on the unit 11. Naturally, the location of the pegs 20a, 20b, 20c and of the sleeves 21a, 21b, 21c could be reversed with the pegs 20a, 20b, 20c on the component, the inertial unit 11, intended to be fixed to the support, the rack 10.

1. Assembly of a peg (1) and of a sleeve (30) of a component (11) and of a support (10) which are intended to be push-fitted one into the other to fix the component (11) to the support (10), the peg (1) comprising an anterior portion (2) to be introduced with clearance into the sleeve (30) and a posterior fixing part (3), characterized in that the posterior part (3) of the peg (1) is designed to compensate for the clearance.

2. Assembly according to claim 1, in which the diameter of the posterior fixing part (3) of the peg (1) is greater than the diameter of the sleeve (30), and the peg (1) is slotted (8).

3. Assembly according to claim 2, in which the peg (1) has lateral flats (9).

4. Assembly according to claim 3, in which the posterior fixing portion (3) comprises a cylindrical part (4).

5. Assembly according to claim 4, in which the posterior fixing portion (3) comprises a part (5) that does not compensate for the clearance.

6. Assembly according to claim 5, in which the part (5) that does not compensate for the clearance is frustoconical and situated behind the cylindrical part (4).

7. Assembly according to claim 6 in which the peg (1) is coated with a graphite deposit. 8. Assembly according to claim 7 intended to fix an inertial unit (11) to a rack (10).
